(19) United States
(12) Patent Application Publication
(10) Pub. No.: US 2009/0015232 A1
(43) Pub. Date: Jan. 15, 2009

(54) METHOD AND DEVICE FOR REGULATING A VOLTAGE SUPPLY TO A SEMICONDUCTOR DEVICE

(76) Inventors: Anton Rozen, Gedera (IL); Michael Priel, Hertzelia (IL); Leonid Smolyansky, Or-Akiva (IL); Boris Bobrov, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/595,908

(22) PCT Filed: Nov. 18, 2004
(86) PCT No.: PCT/IB2004/003939

§ 371 Date: Aug. 22, 2006

(30) Foreign Application Priority Data
Nov. 18, 2003 (GB) 0326862.0
Nov. 18, 2003 (GB) 0326864.6

(51) Int. Cl. G05B 24/02

(52) U.S. Cl. 323/318

(57) ABSTRACT

A device for regulating a voltage supply to a semiconductor device, the device comprising memory for storing a plurality of performance ranges, wherein the respective performance ranges are associated with a respective supply voltage; means for measuring the performance of the semiconductor device; and a regulator for modifying the supply voltage to the semiconductor device if the measured performance of the semiconductor device is not within a predetermined portion of the performance range associated with the voltage supplied to the semiconductor device.

The present invention relates to a method and device for regulating a voltage supply to a semiconductor device.

As the demand for portable electronic devices has increased so correspondingly has the requirement for increased battery life and processor performance.

While processor performance has continued to increase at a rapid rate, improvements in battery performance have not.

Additionally, in many cases the increase in processor performance has resulted in an increased power usage, which could result in many cases in a reduced battery life.

Consequently, there is a continuing drive to reduce power usage.

One solution that manufactures have used to reduce power usage within portable electronic devices has included temporarily turning off unneeded peripherals; blocks of on-chip memory and, during idle periods, the processor itself.

A second solution involves lowering the supply voltage to an integrated circuit to the lowest voltage that is necessary to maintain the performance of the integrated circuit. This solution is based on the principle that the specified voltage supply requirements for an integrated circuit are based upon worst case conditions, for example worst case operational temperature and the quality of the production process (i.e. manufactured process corner), whereas actual conditions are normally better than these. This technique is known as dynamic process temperature compensation DPTC.

DPTC provides the greatest power saving for high MIPS applications.

One technique for determining the lowest voltage that would be needed to maintain the performance of an integrated circuit is to decrease the integrated circuit supply voltage in steps until the integrated circuit is measured to be operating just within a predetermined performance. However, the time taken to perform this operation can still result in a large waste of power.

A third solution involves the dynamic control of processor frequency and voltage, commonly known as dynamic voltage frequency scaling DVFS.

This technique allows the operational frequency of a processor to be reduced when the processor is not fully loaded. Accordingly, low MIPS applications can be executed at a lower frequency and consequently be executed at a lower supply voltage.

DVFS provides the greatest power saving for low MIP applications.

However, to ensure that an application does not fail this technique requires that the frequency of a processor is raised just before the loading of the processor increases.

It is desirable to improve this situation.

In accordance with a first aspect of the present invention there is provided a device for regulating a voltage supply to a semiconductor device according to claim 1.

This provides the advantage of allowing a minimum voltage supply to be determined quickly and without having to perform performance limit calculations.

In accordance with a second aspect of the present invention there is provided a method for regulating a voltage supply to a semiconductor device according to claim 8.

In accordance with a third aspect of the present invention there is provided a device for regulating a voltage supply to a semiconductor device according to claim 19.

This provides the advantage of allowing the voltage supply to an integrated circuit to be set based upon both the processing load on the integrated circuit and the operating conditions and manufacturing process of the integrated circuit. Additionally, short voltage switching times are achievable allowing power saving and optimal voltage levels are set during frequency scaling.

In accordance with a fourth aspect of the present invention there is provided a method for regulating a voltage supply to a semiconductor device according to claim 28.

An embodiment of the invention will now be described, by way of example, with reference to the drawings, of which:

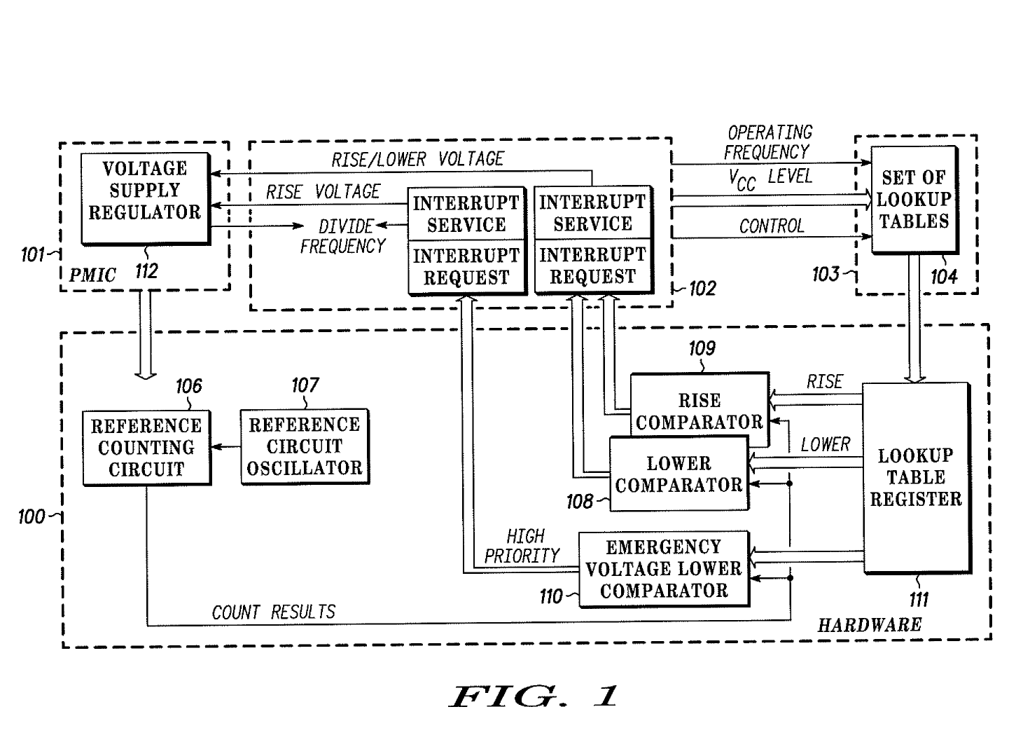

FIG. 1 illustrates an arrangement for regulating a voltage supply to a semiconductor device according to an embodiment of the present invention;

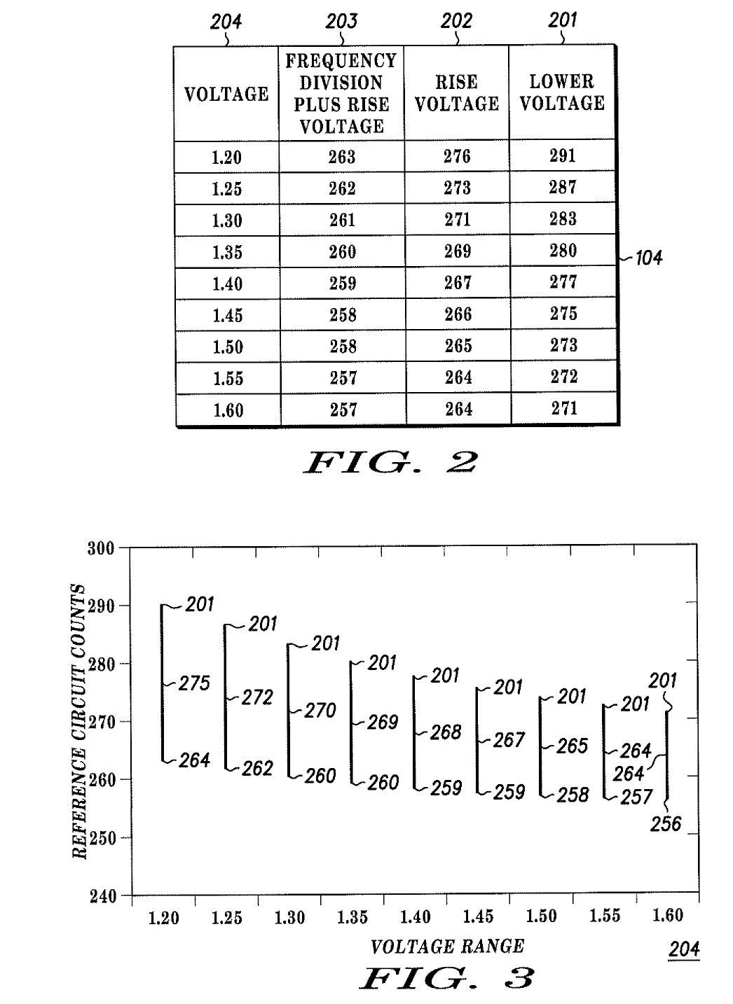

FIG. 2 illustrates a look-up table according to an embodiment of the present invention;

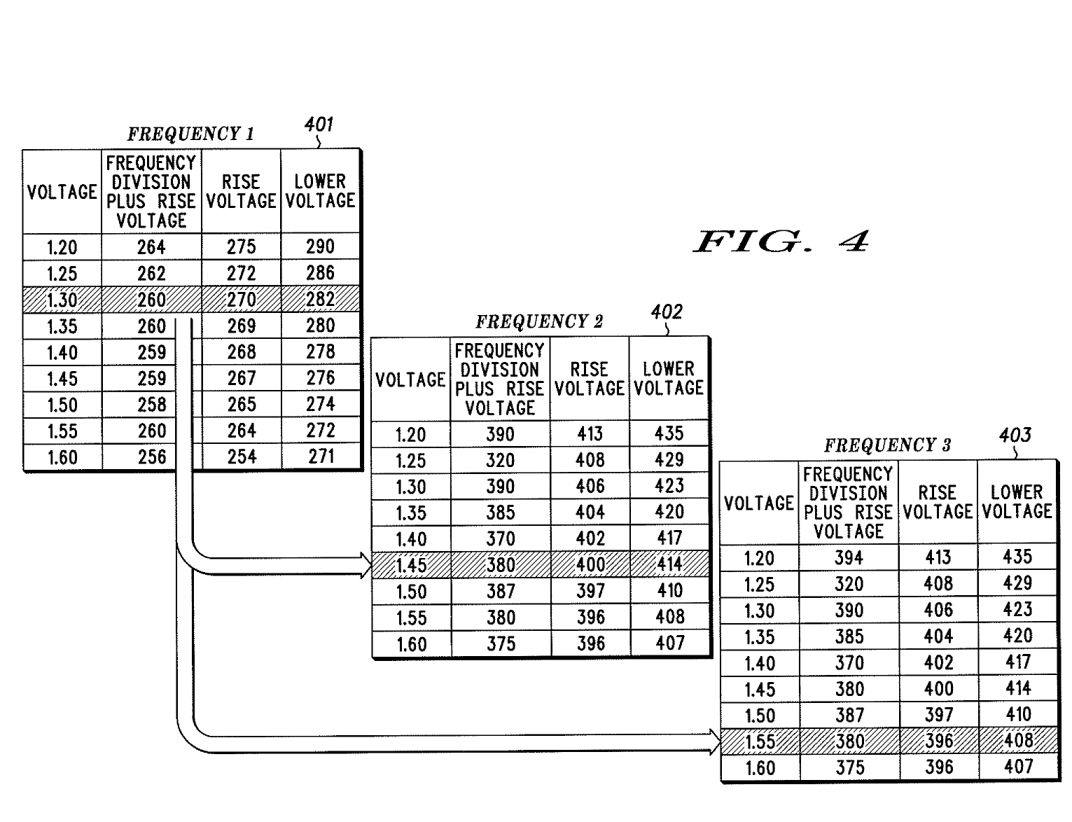

FIG. 3 illustrates a graphical representation of a look-up table according to an embodiment of the present invention and;

FIG. 4 illustrates a set of look-up tables for a set of respective operating frequencies of an integrated circuit according to an embodiment of the present invention.

FIG. 1 shows an integrated circuit 100, a power management module 101 having a voltage supply regulator 112 for providing a supply voltage to the integrated circuit 100, a software module 102 for controlling the regulation of the supply voltage to the integrated circuit 100 and a memory module 103 having a look-up table 104 for storing performance data associated the integrated circuit 100. It is envisaged that the look-up table 104 may comprise a set of look-up tables.

The integrated circuit includes a reference counting circuit 106, a ring oscillator 107 that acts as a reference circuit, three comparators 108, 109, 110 and a look-up table register 111. It should be noted, however, that the comparators 108, 109, 110 and the look-up table register 111 could be located of chip from the integrated circuit 100.

The ring oscillator 107 (i.e. reference circuit) is arranged to generate a free running reference clock signal that is provided to the reference counting circuit 106. The reference circuit 107 is a subset of the circuits formed on the integrated circuit 100 and is used as a measure of the performance of the integrated circuit 100. The purpose of using the reference circuit 107 is to determine the performance of the integrated circuit 100 is to minimise the complexity of the device for regulating the voltage supply to the integrated circuit 100. However, it could also be possible to measure the operating performance of all of the circuits on the integrated circuit 100.

The frequency of the reference circuit 107 clock signal is related to how the reference circuit 107 is performing, and is dependent upon the operating conditions of the reference circuit 107, such as the operating temperature of the integrated circuit, the supply voltage supplied to the integrated circuit 100 and the manufactured process corner.

As stated above the reference circuit clock signal is a clock signal that is based upon the process corner case, the environmental conditions and the operating voltage of the integrated circuit 100. This is in contrast to the operating frequency of the integrated circuit 100, which is the clock rate to which the integrated circuit is working too.

The reference counting circuit 106 measures the clock signal, which as stated above is a reflection of the performance of the reference circuit 107, and provides the measurements to the comparators 108, 109, 110.

The comparators 108, 109, 110 are coupled to the look-up table register 111, with the look-up table register 111 also being coupled to the memory module 103 for accessing information stored in the look-up table (or set of look-up tables) 104 contained within the memory module 103.

As shown in FIG. 2 the look-up table 104, within the memory module 103, is preloaded with a set of reference circuit count values, where each set of reference circuit count values is associated with a respective supply voltage. It is also envisaged that the look-up table 205 may be preloaded with a set of reference circuit count values, where each set of reference circuit count values is associated with a respective supply voltage for the given operating frequency. Each set of reference circuit count values define a range of performance for the reference circuit 107, where, in this embodiment, the reference circuit count values differ for the different supply voltages, a graphical representation of the data is shown in FIG. 3.

Each set of reference circuit count values stored within the look-up table 104 defined three performance markers (i.e. three levels of performance of the integrated circuit). The first level 201, the upper performance limit, indicates the reference circuit count value that corresponds to the upper performance limit for the integrated circuit 100 at a specified voltage (and possibly at a given frequency). The second level 202, the lower performance limit, indicates the reference circuit count value that corresponds to the lowest acceptable performance level for the integrated circuit 100 at a specified voltage. (and possibly at a given frequency). The third level 203, the critical lower performance level, indicates a reference circuit count value that corresponds to a level of performance at which logic operation failures within the integrated circuit 100 could occur for a specified voltage (and possibly at a given frequency).

The values for the three performance levels 201, 202, 203 include a performance guard margin, which corresponds to an additional safety margin added to each of the determined performance levels for the reference circuit 105 to account for possible differences between the performance of the reference circuit 107 and the integrated circuit 100 as a whole. If the performance of the integrated circuit 100 as a whole was being measured, rather than just the reference circuit 107, it would be unnecessary to include a guard margin/safety margin within the performance level values.

It is envisaged that the information stored in a set of look-up tables 104 may correspond to predefined DPTC values for the integrated circuit.

By way of illustration, FIG. 2 shows that for the current embodiment nine supply voltages 204 for the integrated circuit 100 have been defined where each supply voltage is associated with a respective performance range (i.e. a range of reference circuit count values), where the performance range for the first voltage of 1.2 provides a reference circuit count value for the upper performance limit of 290 counts, a reference circuit count value for the lower performance limit of 275 counts and a reference circuit count value for the critical lower performance level of 264 counts.

The performance limits stored in the look-up table 104 are based on two main parameters: IR (i.e. current resistance) drop value (voltage reduction due to current flow through metal interconnects) and the accuracy of the voltage supply regulator 112. In an enhanced embodiment of the present invention, supply voltages are associated with an operating frequency and a set of look-up tables are used, Here the performance limits stored in each look-up table are based on two main parameters: IR (i.e. current, resistance) drop value (voltage reduction due to current flow through metal interconnects) and the accuracy of the voltage supply regulator 112 for the specific operating frequency to which the relevant look-up table applies.

The critical lower performance level 203 is set by the minimal required voltage level and IR drop value, where IR drop value depends on existing absolute supply voltage level. The critical lower performance level 203 is set such that if the maximum IR drop occurs the supply voltage inside the integrated circuit 100 would be so low that the most constrained delay paths might begin to malfunction.

The lower performance limit 202 is higher than the critical lower performance level 203 by a value proportional to the voltage raise of one minimum step of the voltage supply regulator 112 plus some spare margin.

The higher performance limit 201 is higher than the lower performance limit 202 by a value proportional to a voltage raise of one and the half voltage steps of the voltage supply regulator 112 plus some spare margin. Alternatively it is envisaged that the higher performance limit 201 is higher than the lower performance limit 202 by a value proportional to a voltage rise of one and a half voltage steps of the voltage supply regulator 112 within the power management module 101 plus some spare margin.

The software module 102, which receives information from the power management module 101 as to the voltage supply being provided to the integrated circuit 100, is arranged to load the three reference circuit count performance values associated with the supplied voltage into the look-up table register 111.

In the enhanced embodiment of the present invention, the software module 102 receives information from the integrated circuit 100 information on the operating frequency of the integrated circuit 100 and information from the power management module 101 on the voltage supply being provided to the integrated circuit 100. The software module 102 then loads the three reference circuit count performance values for the look-up table applicable to the operating frequency of the integrated circuit 100 and associated with the voltage supplied to the look-up table register 111.

The technique for changing the operational frequency of the integrated circuit 100 in accordance with the processor load requirements of an application (i.e. DVFS) are well known to a person skilled in the art and for the purposes of this embodiment will not be described in any further detail.

The look-up table register 111 is arranged to provide the upper performance level value and the lower performance level reference circuit count value to the first comparator 108 and second comparator 109 respectively and the critical lower performance level reference circuit count value to the third comparator 110.

The first comparator 108 compares the measured reference count value received from the reference counting circuit 106 with the reference circuit count value received from the look-up table register 111 (i.e. the upper performance level reference circuit count value).

If the measured reference count value falls below the upper performance level reference circuit count value the first comparator 108 provides no output.

If the measured reference count value is above the upper performance level reference circuit count value (i.e. the supply voltage is unnecessarily high) the first comparator 108 issues an interrupt request to the software module 102 requesting a voltage decrease. On receipt of the interrupt request the software module 102 initiates an instruction to the power management module 101 to lower the voltage supply to the integrated circuit 100 to the next lower voltage supply level within the look-up table and the software module 102 initiates the loading of the three reference circuit count performance values associated with the new supplied voltage into the look-up table register 111.

The second comparator 109 compares the measured reference circuit count value received from the reference counting circuit 106 with the reference circuit count value received from the look-up table register 111 (i.e. the lower performance level reference circuit count value).

If the measured reference count value is higher than the lower performance level reference circuit count value the second comparator 109 provides no output.

If the measured reference count value is below the lower performance level reference circuit count value (i.e. the supply voltage is too low) the second comparator 109 issues an interrupt request to the software module 102 requesting a voltage increase. On receipt of the interrupt request the software module 102 initiates an instruction to the power management module 101 to increase the voltage supply to the integrated circuit 100 to the next highest voltage supply level within the look-up table and the software module 102 initiates the loading of the three reference circuit count performance values associated with the new supplied voltage into the look-up table register 111.

The third comparator 110 compares the measured reference circuit count value received from the reference counting circuit 106 with the reference circuit count value received from the look-up table register 111 (i.e. the critical lower performance reference circuit count value).

If the measured reference circuit count value falls below the critical lower performance level reference circuit count value, which is placed at a lower count level to the lower performance level, this could indicate that a previous request to increase the voltage supply to the integrated circuit 100 is occurring too slowly and/or the operating environment conditions are degrading at a fast rate. In response to the measured reference circuit count value falling below the critical lower performance level the third comparator 110 issues a high priority interrupt request to the software module 102 requesting a voltage increase. On receipt of the high priority interrupt request the software module places a high priority instruction to the power management module 101 requesting an increase in the voltage supply to the integrated circuit 100 to the next higher voltage supply level and, if not already performed as a result of any previous voltage request interrupts from the second comparator 109, the software module 102 initiates the loading of the three reference circuit count performance values associated with the new supply voltage to the look-up table register 111.

In the enhanced embodiment of the present invention, when the operational frequency of the integrated circuit 100 is changed (by the DVFS operation) the software module 102 references the look-up table applicable to the new operating frequency and determines which three reference circuit count performance values to load into the look-up table register 111 by performing a comparison between the measured reference count value and the set of reference circuit count performance values within the selected look-up table. Notably the performance values stored in the look-up table comprise a plurality of process temperature compensation voltage values, where the respective voltage values are associated with an operational frequency of the semiconductor device.

FIG. 4 shows by way of illustration an example of a memory module having a set of look-up tables 104 having three look-up tables 401, 402, 403 associated with three separated operating frequencies of an integrated circuit 100. Each of the three look-up tables 401, 402, 403 has nine sets of reference circuit count performance values.

By way of example, when the integrated circuit 100 is operating at the first frequency the software module 102 determines with reference to the first look-up table 401 from the measured reference count value, as described above, that the optimum supply voltage would be 1.3. If, due to a change in processing loading requirements, the operating frequency of the integrated circuit 100 is changed to the second frequency the software module 102 determines with reference to the second look-up table 402 and the measured reference count value that the optimum supply voltage should be 1.45. Correspondingly, if due to a further change in processing loading the operating frequency of the integrated circuit 100 is change to the third frequency the software module 102 determines with reference to the third look-up table 403 and the measured reference count value that the optimum supply voltage should be 1.55.

It will be apparent to those skilled in the art that the disclosed subject matter may be modified in numerous ways and may assume many embodiments other than the preferred forms specifically set out as described above, for example the above embodiments could be arranged such that the look-up table 104 or each look-up table could have more or less than three performance levels and the change in voltage could be to voltage levels other than the next value up or down from the current voltage value within the look-up table 104, rather than the comparators 108, 109, 110 being arranged to send a signal when a performance level has been reached the comparators 108, 109, 110 could be arranged to stop sending a signal when a performance level has be reached. In addition, the comparators 108, 109, 110 could be arranged to stop sending a signal when a performance level has be reached and the DPTC values stored in the set of look-up tables could be derived in alternative ways.

1. A device for regulating a voltage supply to a semiconductor device, said device comprising:
a memory for storing a plurality of performance ranges, wherein said performance ranges are associated with a respective supply voltage; a measuring function for measuring a performance of said semiconductor device; and
a regulator wherein the device is characterised in that the memory stores a performance limit of the semiconductor device and a reference circuit is coupled to the memory and is arranged to determine a lowest supply voltage required to maintain a performance of the semiconductor device at a given operational frequency and modify the supply voltage to said semiconductor device if a measured performance of said semiconductor device is not within a predetermined portion of said performance range associated with said voltage supplied to said semiconductor device.

2. A device according to claim 1, wherein said performance limits stored in the memory are based on two parameters, the first parameter being current resistance drop value and the second parameter being an accuracy of the regulator.

3. A device according to claim 1, wherein said performance range is defined to have an upper performance limit such that if said measured performance of the semiconductor device is above said upper performance limit said regulator is arranged to reduce said voltage supplied to said semiconductor device.

4. A device according to claim 1, wherein said performance range is defined to have a lower performance limit such that if said measured performance of said semiconductor device is below said lower performance limit said regulator is arranged to increase said voltage supplied to the semiconductor device.

5. A device according to claim 1, wherein said performance range is defined to have a critical lower performance limit such that if said measured performance of said semiconductor device is below said critical lower performance limit said regulator is arranged to increase said voltage supplied to said semiconductor device.

6. A device according to claim 1, wherein said measuring function is arranged to measure said performance of said semiconductor device by measuring said performance of a reference circuit that forms part of said semiconductor device.

7. A device according to claim 6, wherein said plurality of performance ranges are arranged to include a performance guard margin to compensate for differences between said measured performance of said reference circuit and an actual performance of a complete integrated circuit.

8. A device according to claim 1, further comprising a ring oscillator, wherein said measuring function measures a frequency of said ring oscillator for providing a measure of said performance of an integrated circuit.

9. A method for regulating a voltage supply to a semiconductor device, said method comprising:
storing a plurality of performance ranges of the semiconductor device wherein respective performance ranges are associated with a respective supply voltage;
measuring a performance of said semiconductor device;
wherein the method is characterised by the step of determining a lowest supply voltage required to maintain a performance of the semiconductor device at a given operational frequency and modifying said supply voltage to said semiconductor device if a measured performance of said semiconductor device is not within a predetermined portion of a performance range associated with said voltage supplied to said semiconductor device.

10. A device for regulating a voltage supply to a semiconductor device according to claim 1, wherein the memory also stores a plurality of process temperature compensation voltage values, wherein said respective process temperature compensation voltage values are associated with a respective operational frequency for said semiconductor device, such that if said operational frequency of said semiconductor device changes to a new operational frequency, said supply voltage is modified by said regulator to substantially a same value as said process temperature compensation voltage value associated with said new operation frequency.

11. A device according to claim 10, wherein each process temperature compensation voltage value associated with a respective operational frequency is determined from a plurality of performance ranges stored in said memory wherein said respective performance ranges are associated with a respective supply voltage.

12. A device according to claim 11, further comprising a measuring function for measuring the performance of the semiconductor device, wherein said regulator is arranged to modify said supply voltage to said semiconductor device if a measured performance of said semiconductor device is not within a predetermined portion of a performance range associated with said voltage supplied to the semiconductor device for a given frequency.

13. A device according to claim 12, wherein said performance range is defined to have an upper performance limit such that if said measured performance of said semiconductor device is above said upper performance limit said regulator is arranged to reduce said voltage supplied to said semiconductor device.

14. A device according to claim 12, wherein said performance range is defined to have a lower performance limit such that if said measured performance of said semiconductor device is below said lower performance limit said regulator is arranged to increase said voltage supplied to said semiconductor device.

15. A device according to claim 12, wherein said performance range is defined to have a critical lower performance limit such that if said measured performance of said semiconductor device is below said critical lower performance limit said regulator is arranged to increase said voltage supplied to said semiconductor device.

16. A device according to claim 12, wherein said measuring function is arranged to measure the performance of said semiconductor device by measuring said performance of a reference circuit that forms part of said semiconductor device.

17. A device according to claim 16, wherein said plurality of performance ranges are arranged to include a performance guard margin to compensate for differences between said measured performance of said reference circuit and an actual performance of said semiconductor device.

18. A device according to claim 12, further comprising a ring oscillator, wherein said measuring function measures a frequency of said ring oscillator for providing a measure of a performance of the semiconductor device.

19. A method for regulating a voltage supply to a semiconductor device, according to claim 9 wherein:
said set of storing comprises storing a plurality of process temperature compensation voltage values, wherein respective process temperature compensation voltage values are associated with a respective operational frequency for said semiconductor device; and
said step of modifying comprises modifying a supply voltage to said semiconductor device if an operational frequency of said semiconductor device changes to a new operational frequency, wherein said supply voltage is modified to substantially a same value as a process temperature compensation voltage value associated with said new operational frequency.

20. A device for regulating a voltage supply to a semiconductor device, said device comprising:
a memory for storing a plurality of process temperature compensation voltage values, wherein said respective process temperature compensation voltage values are associated with a respective operational frequency for said semiconductor device; and
a regulator for modifying said supply voltage to said semiconductor device if said operational frequency of said semiconductor device changes to a new operational frequency, and wherein the device is characterised in that the memory stores a performance limit of the semiconductor device and a reference circuit is coupled to the memory and is arranged to determine a lowest supply voltage required to maintain a performance of the semiconductor device at a given operational frequency and modify said supply voltage to substantially a same value as said process temperature compensation voltage value associated with said new operational frequency,

21. A device according to claim 20, wherein said performance limit stored in the memory is based on a current resistance drop value and an accuracy of the regulator.

22. A device according to claim 20, wherein each process temperature compensation voltage value associated with a respective operational frequency is determined from a plurality of performance ranges stored in said memory wherein said respective performance ranges are associated with a respective supply voltage.

23. A device according to claim 22, further comprising a measuring function for measuring the performance of the semiconductor device, wherein said regulator is arranged to modify said supply voltage to said semiconductor device if a measured performance of the semiconductor device is not within a predetermined portion of a performance range associated with said voltage supplied to said semiconductor device for a given frequency.

24. A device according to claim 23, wherein said performance range is defined to have an upper performance limit such that if said measured performance of said semiconductor device is above said upper performance limit said regulator is arranged to reduce said voltage supplied to said semiconductor device.

25. A device according to claim 23, wherein said performance range is defined to have a lower performance limit such that if said measured performance of said semiconductor device is below said lower performance limit said regulator is arranged to increase said voltage supplied to said semiconductor device.

26. A device according claim 23, wherein said performance range is defined to have a critical lower performance limit such that if the measured performance of said semiconductor device is below said critical lower performance limit said regulator is arranged to increase said voltage supplied to said semiconductor device.

27. A device according to claim 23, wherein said measuring function is arranged to measure the performance of said semiconductor device by measuring said performance of a reference circuit that forms part of said semiconductor device.

28. A device according to claim 27, wherein said plurality of performance ranges are arranged to include a performance guard margin to compensate for differences between said measured performance of said reference circuit and an actual performance of said semiconductor device.

29. A device according to claim 23, further comprising a ring oscillator, wherein said measuring function measures a frequency of said ring oscillator for providing a measure of a performance of the semiconductor device.

30. A method for regulating a voltage supply to a semiconductor device, said method comprising.
storing a plurality of process temperature compensation voltage values, wherein respective process temperature compensation voltage values are associated with a respective operational frequency for said semiconductor device; and
modifying a supply voltage to said semiconductor device if an operational frequency of said semiconductor device changes to a new operational frequency, wherein the method is characterised by the step of determining a lowest supply voltage required to maintain a performance of the semiconductor device at a given operational frequency and modifying said supply voltage to substantially a same value as a process temperature compensation voltage value associated with said new operational frequency.
